(19) United States
(12) Patent Application Publication
(10) Pub. No.: US 2006/0041693 A1
(43) Pub. Date: Feb. 23, 2006

(54) Asynchronous decoupler

(75) Inventors: Daniele Mangano, Messina (IT); Salvatore Pisasale, Catania (IT); Carmine Ciofi, Messina (IT); Carmelo Pistritto, Catania (IT)

Correspondence Address: SEED INTELLECTUAL PROPERTY LAW GROUP PLLC, 701 FIFTH AVENUE, SUITE 6300, SEATTLE, WA, 98104-7092, US

(73) Assignee: STMicroelectronics S.r.l., Agrate Brianza (IT)

(21) Appl. No.: 10/856,131

(22) Filed: May 27, 2004

(51) Int. Cl. G06F 3/06; G06F 3/00

(52) U.S. Cl. 710/58

(57) ABSTRACT

A decoupler that allows for asynchronous communication between two synchronous IP cores. The decoupler reduces or eliminates the need for distribution and balancing of the clock. More specifically, the decoupler provides the ability to decouple an IP core from the interconnect clock domain, thereby reducing the need for clock balancing. The decoupler is inserted between a source IP core and a target IP core, and may include two interfaces, one located near the source and another located near the target. Synchronous data messages are converted to asynchronous data messages for transmission across a physical connection. Once the asynchronous data message is received by the interface near the target or source, the data message is converted back to a synchronous message.

### BACKGROUND OF THE INVENTION

1. Field of the Invention

This invention relates generally to integrated circuit design, and more particularly to clock routing problems in a system on a chip (SoC).

2. Description of the Related Art

Many of today's integrated circuit (IC) designs consist of a complete system on a chip (SoC). An SoC integrates multiple pre-designed and reusable circuits, termed “cores,” onto a single IC. This integration allows SoC manufacturers to reduce design time and lower production costs.

To allow communication between the cores, generally bus systems are used. For example, AMBA defines a bus hierarchy including a system bus and a peripheral bus, wherein the two buses are linked via a bridge that serves as the master to the peripheral bus. In a typical configuration, the SoC processor(s), memory controllers, on-chip memory, and DMA controllers are connected to the system bus, which handles the high-speed bus interconnections on the chip. The slower peripherals are connected to the slower, simpler peripheral bus.

The cores may operate at different clock frequencies and the frequencies of different clocks may or may not be integral multiples of one another. In addition, current SoCs may have multiple modes of operation that could result in different rates of operation. For example, a core may have a high-frequency mode whenever it is necessary to process data at a faster rate and a low-frequency mode whenever it is necessary to reduce power dissipation. Such different modes of operation require different clocks operating at different frequencies.

One of the main problems in the design of SoCs is the routing and balancing of clocks. The typical approach that is used is based on the possibility to control the clock delays and skews and to control the signal and data bus delays. However, as more cores are being squeezed onto an SoC, the complexity of clock routing is becoming overly burdensome.

There are a number of solutions to the clock-routing problem, but each has its own difficulties. Solutions that use delay-insensitive coding require overhead logic and wires in order to support asynchronous design. Solutions that do not use delay-insensitive coding need to control and balance, at the physical layer, the delays of the wires that interconnect the system. Delay-insensitive encoding is a coding style mechanism such that a request is encoded into the data and propagated towards a target core without taking care of the wire delays.

In summary, the disadvantages of the prior art include that it is impossible to overlap with existing synchronous protocols when using solutions such as AMBA Bus, MARABLE/CHAIN, QUASI Delay-insensitive Bus, and GALS. The later three of these also require overhead logic and wires. With AMBA Bus and Asynchronous Memory Bridge, there is a need to control and balance wire delays. With MARABLE/CHAIN and QUASI it is also impossible to interconnect to synchronous modules.

Thus, there is a need for a system that can use existing protocols and reduce the need to control and balance wire delays, while allowing communication between disparate clock domains.

### BRIEF SUMMARY OF THE INVENTION

An embodiment of the present invention includes a decoupler that allows for asynchronous communication between two synchronous IP cores. The decoupler reduces or eliminates the need for distribution and balancing of the clock. More specifically, the decoupler provides the ability to decouple an IP core from the interconnect clock domain, thereby reducing the need for clock balancing. Additionally, existing synchronous protocols may be used with the decoupler.

The decoupler is inserted between a source IP core and a target IP core, and may include two interfaces, one located near the source and another located near the target. Synchronous data messages from the source are converted to asynchronous data messages for transmission across a physical connection. Once the asynchronous data message is received by an interface near the target, the data message is converted back to a synchronous message based on the target clock. Thus, a major part of the transmission is in an asynchronous mode independent of the clocks of either the source or target.

These advantages and other advantages and features of the invention will become apparent from the following description of an embodiment, which proceeds with reference to the following drawings.

### BRIEF DESCRIPTION OF THE SEVERAL VIEWS OF THE DRAWINGS

FIG. 1 shows a high-level diagram of one embodiment of the present invention showing a decoupler coupled between source and target IP cores.

FIG. 2 shows a particular embodiment With a system bus coupling together multiple initiators and targets and showing the decoupler coupled between the system bus and one to the target IP cores.

FIG. 3 shows another embodiment with the decoupler coupled between source and target IP cores and showing an initiator interface and a target interface.

FIG. 4 is an electrical circuit diagram showing further details of a synchronous interface portion of the initiator interface of FIG. 3.

FIG. 5 is an electrical circuit diagram showing further details of an asynchronous transmitter/receiver portion of the initiator interface of FIG. 3.

FIG. 6 is an electrical circuit diagram showing further details of the transmitter portion of FIG. 5.

FIG. 7 is a an electrical circuit diagram showing further details of the receiver portion of FIG. 5.

FIG. 8 is an electrical circuit diagram showing details of a coder circuit located in the transmitter portion of FIG. 6.

FIG. 9 is an electrical circuit diagram showing details of a decoder circuit located in the receiver portion of FIG. 7.

FIG. 10 is an electrical circuit diagram showing further details of the target interface of FIG. 3.

FIG. 11 shows a flowchart of a method for transmitting a message from a source IP core to a target IP core.

### DETAILED DESCRIPTION OF THE INVENTION

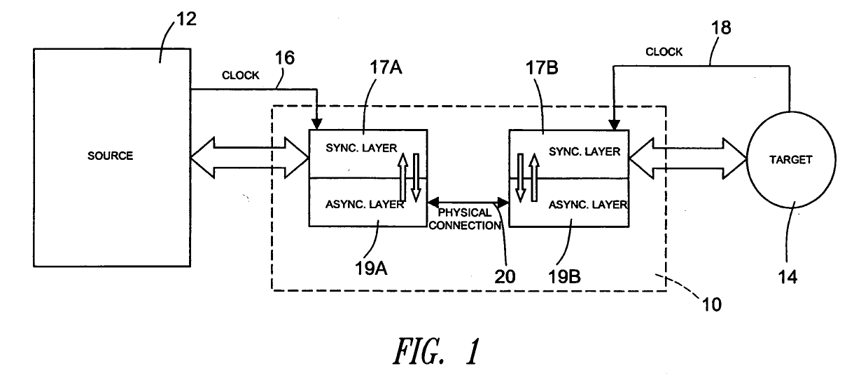

FIG. 1 shows a conceptual diagram of a decoupler 10 coupled between source 12 and target 14 IP cores. The source 12 operates at a first clock frequency as indicated at 16 and the target operates at a second clock frequency as indicated at 18, although they both may operate at the same frequency. The source 12 and target 14 communicate via respective synchronous layers 17A, 17B, meaning that the source and target communicate using a synchronous protocol (a wide variety of synchronous protocols may be used). The respective synchronous layers 17A, 17B of the decoupler 10 receive synchronous communications from the source 12 and target 14 IP cores, convert the communications to respective asynchronous layers 19A, 19B which transmit the communications over a physical connection 20 independently of the clock signals 16, 18. The asynchronous layers may implement delay-insensitive coding where delays due to gates do not affect the timing of the circuit. Generally, the physical connection 20 covers a majority of the distance between the source 12 and target 14, which substantially reduces the need for clock distribution and balancing.

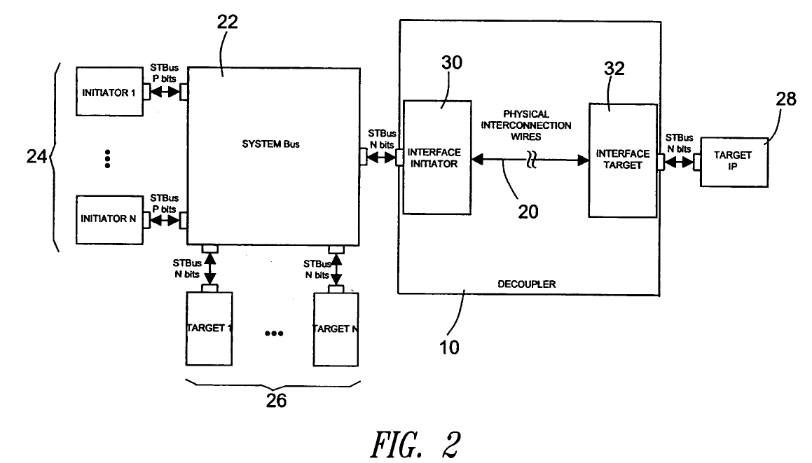

FIG. 2 shows a particular implementation of using the decoupler 10 wherein a source is connected to the decoupler using a system bus 22. Different types of system buses may be used, such as the STBus designed by STMicroelectronics, the assignee of the present invention. The components interconnected by the system bus 22 are either initiators, shown at 24, (which initiate transactions on the bus by sending requests), or targets 26(which respond to requests). The bus architecture may be decomposed into nodes (sub-buses in which initiators and targets can communicate directly), with internode communications being performed through FIFO buffers (not shown). One target 28 is coupled to the system bus 22 through the decoupler 10. Other targets may also communicate through a similar type of decoupler if desired. Two interfaces 30, 32 are shown at opposite ends of a physical interconnection 20 within the decoupler 10. Interface 30 is coupled to the system bus 22 and is a converter that converts a synchronous communication from the system bus to an asynchronous communication for transmission over the physical interconnection 20. The asynchronous communication is received at the interface 32, which is also a converter that converts the communication into a synchronous communication needed for the target 28.

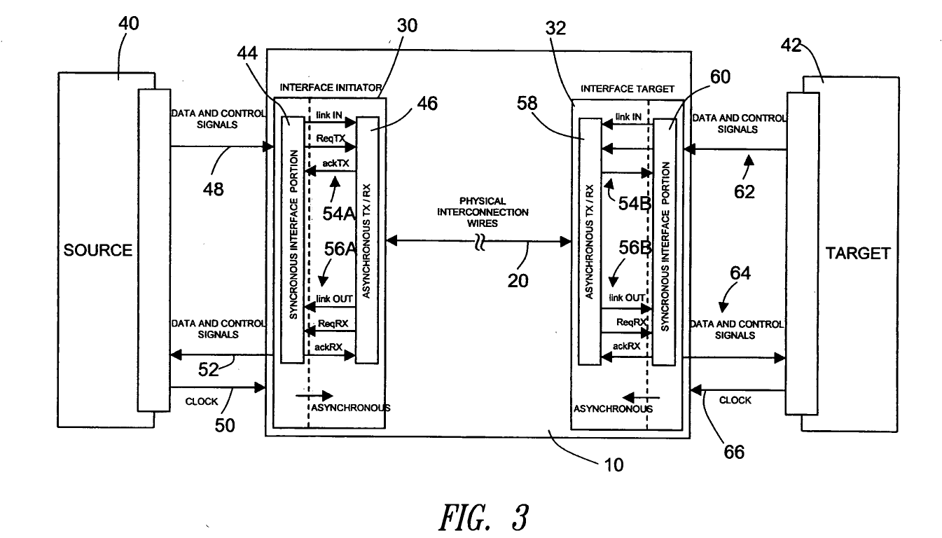

FIG. 3 shows another embodiment with the decoupler 10 coupled between a source IP core 40, which is the initiator, and a target IP core 42. The interface initiator 30 is shown having a synchronous interface portion 44 and an asynchronous interface portion 46. The synchronous interface portion 44 has as inputs, data and control signals 48 from the source 40 and a clock input 50, also from the source. The interface portion 44 also outputs data and control signals 52 to the source 40 in the form of a response. Two sets of communication lines 54A, 56A couple together the asynchronous interface portion 46 and the synchronous interface portion 44. Set 54A includes a data line (link IN), a request line (ReqTX) and an acknowledge line (AckTX) to implement a basic request/acknowledge protocol well understood in the art. The set 56A also includes a data line (link OUT)(which transfers data from portion 46 to portion 44), a request line (ReqRX) and a acknowledge line (AckRX).

The interface target 32 also includes an asynchronous interface portion 58 and a synchronous interface portion 60. The asynchronous interface portion 58 of the interface target 32 is coupled to the asynchronous interface portion 46 of the interface initiator 30 through the physical interconnection 20. The synchronous interface portion 60 is coupled to the asynchronous portion 58 with two sets 54B, 56B of communication lines similar to sets 54A, 56A and so numbered for simplicity. Likewise, the target 42 is coupled with the synchronous interface portion 60 using communication lines 62, 64 and clock line 66.

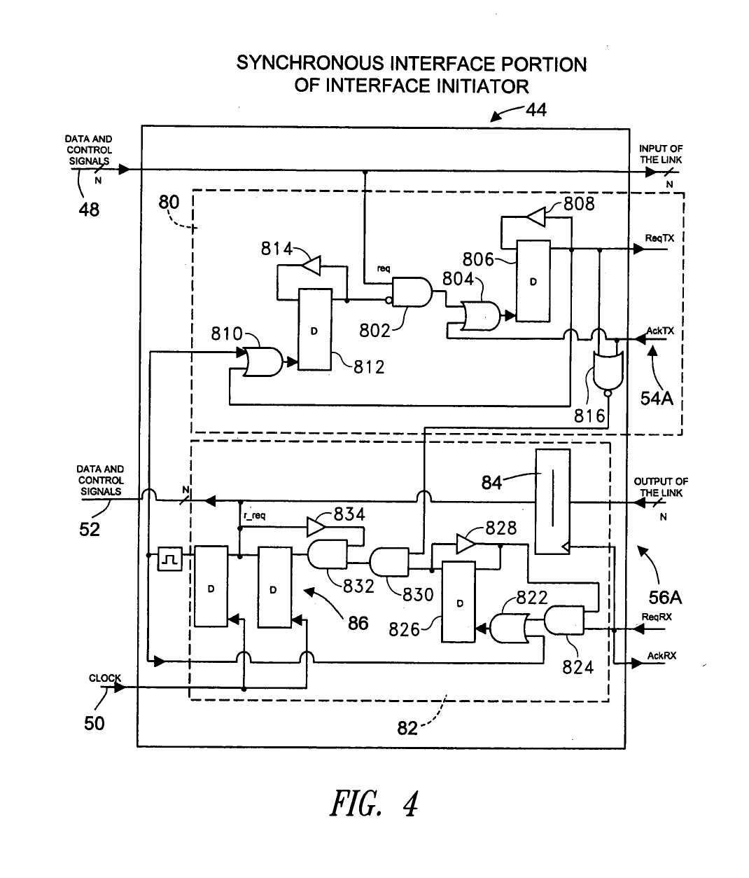

FIG. 4 shows further details of the synchronous interface portion 44. Combinatorial logic 80 receives the data and control signals 48 from the source 40 and generates a ReqTX signal, which is included in the set of communication lines 54A, indicating a request for transmission. The circuit 80 is reset when an AckTX is received, indicating the circuit is ready for the next communication. The circuit 80 includes an AND gate 802 with a first input coupled to receive a request signal req of the data and control signals 48, an inverting, second input, and an output coupled to a first input of an OR gate 804. The OR gate 804 also has a second input coupled to receive the AckTX signal and an output coupled to a first input of a D-type flip-flop 806. The D-type flip-flop 806 has a second input and an output coupled together via a buffer gate 808, the output providing the ReqTX signal. The circuit 80 also includes an OR gate 810 having a first input coupled to the output of the D-type flip-flop 806, a second input, and an output coupled to a first input of another D-type flip-flop 812. The D-type flip-flop 812 has a second input and an output coupled together via a buffer gate 814, the output also being coupled to the inverting, second input of the AND gate 802. The combinatorial logic 80 also includes a NOR gate 816 having inputs coupled respectively to the ReqTX and AckTX signals and an output coupled to the combinatorial logic 82.

Combinatorial logic 82 includes an N-bit wide memory buffer 84 for receiving messages from the asynchronous portion 46. The ReqRX and AckRX coupled to the combinatorial logic 82 are from the set of communication lines 56A and are used to receive and acknowledge a new message from the asynchronous interface portion 46. Dual D flip-flops shown at 86 are used to receive the clock 50 and are back-to-back to eliminate metastability in a well-known manner. As further described below, the N input signals of set 54 (where N may be any number) are designated as the input of the link and are passed to the asynchronous interface portion 46. Additionally,, N signals from the portion 46 are received in buffer 84 to be passed in a synchronous manner to the source 40.

The output of the Dual D flip-flops 86 is coupled to the second input of the OR gate 810 of the combinatorial logic 80 and to a first input of an OR gate 822. The OR gate 822 has a second input coupled to the output of an AND gate 824 that has a first input coupled to receive the ReqRX signal. The output of the OR gate 822 is coupled to a first input of a D flip-flop 826 that has a second input and an output coupled together via a buffer gate 828. The output of the D flip-flop 826 is coupled through two AND gates 830, 832 to an input of the Dual D flip-flops 86. The AND gate 830 has an input coupled to the output of the NOR gate 816 of the combinatorial logic 80 and the AND gate 832 has an input coupled to receive a control signal r req of the data and control signals 52 via a buffer gate 834.

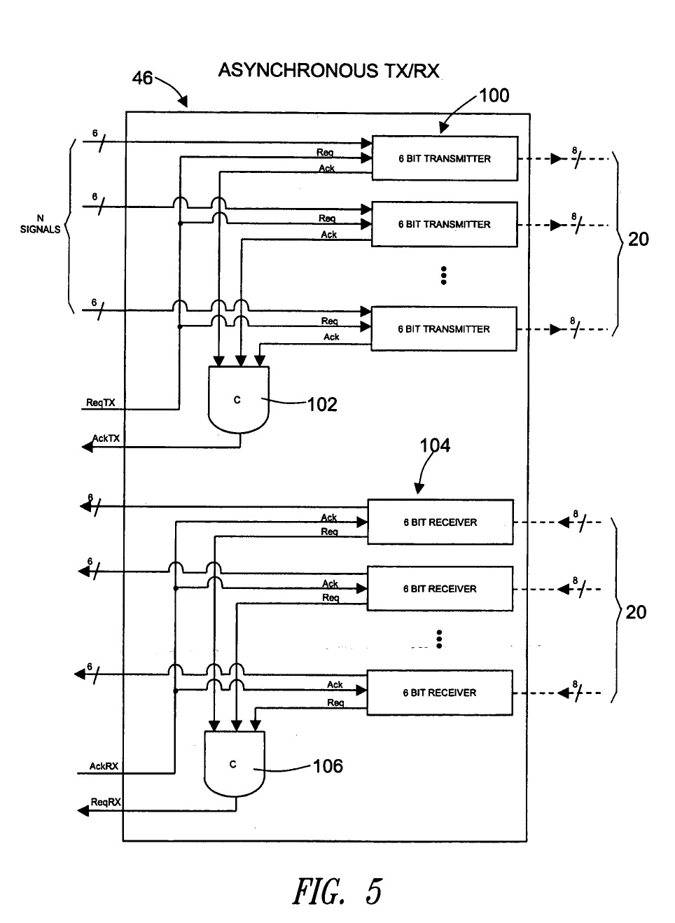

FIG. 5 shows further details of the asynchronous interface portion 46. The N signals of the input of the link from set 54 (from FIG. 4) are shown divided into groups 6 bits wide to be transmitted over the physical interconnection 20. Each of the 6-bit transmitters, shown generally at 100, store data after receiving the ReqTX signal from the synchronous portion 44. When the data is collected, each transmitter 100 generates an Ack signal, which are combined in AND gate 102. When all the Ack signals are activated, an AckTX signal is sent back the synchronous portion 44 indicating the message was received. A group of 6-bit receivers, shown generally at 104, receive data from physical interconnection 20 and when one of the receivers 104 has completed reading the data it activates its respective Req signal. When all the receivers 104 are ready, an AND gate 106 activates the ReqRX signal indicating to the synchronous portion 44 that a message is ready to be transmitted. After the message is received in the synchronous portion 44, an AckRX signal is received to reset the receivers 104.

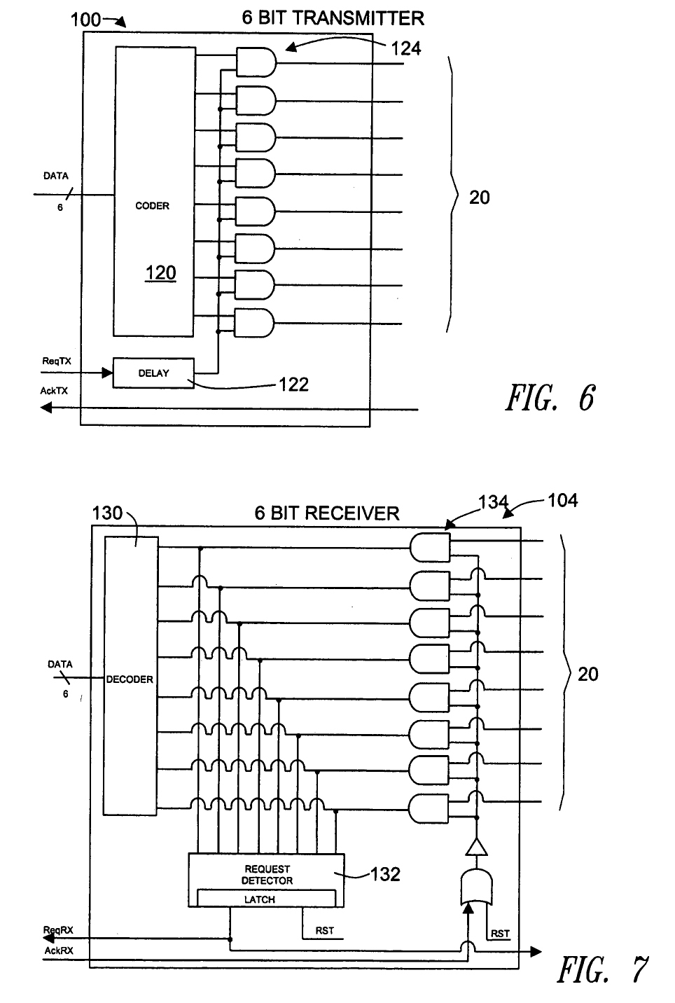

FIG. 6 shows further details of one of the transmitters 100. The transmitter receives a 6-bit input and outputs 8 bits across the physical interconnection 20. A coder 120 reproduces the input data on part of the physical interconnection 20, but also generates a number of check bits to ensure the integrity of the data after transmission, as further described below. A delay 122 is used to ensure that all of the transmitters 100 have a substantially simultaneous transmission. A bank of AND gates 124 is used in combination with the delay 122 to control transmission of the output data from the coder 120.

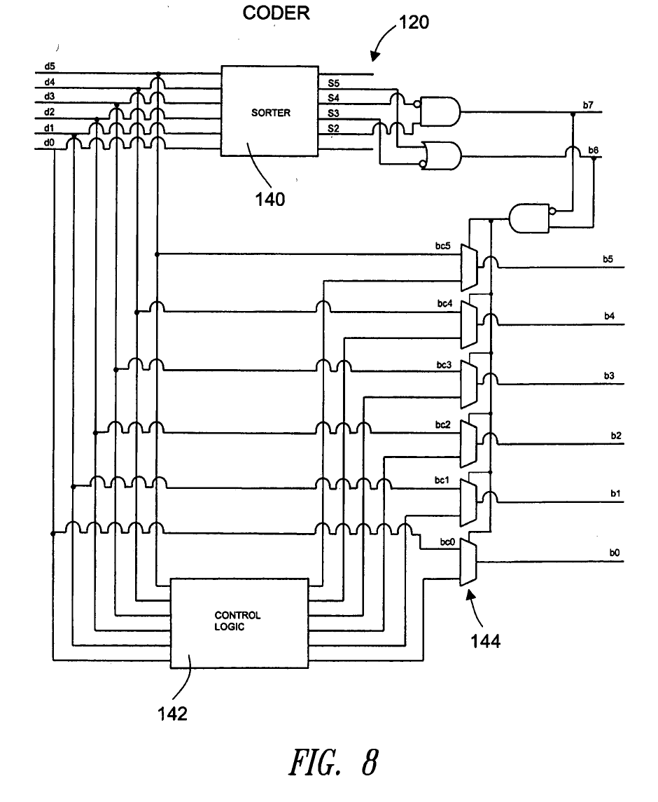

FIG. 7 shows further details of the receiver 104. The receiver receives 8 bits of data from the physical interconnection 20 and converts it into 6 bits of data. A decoder 130 analyzes the top two bits of the message and based on these bits either passes the lower six bits straight through or passes through a logical combination of the bits, as further described below. A request detector 132 checks if there is at least one logical high on the input signal, and if yes, sets the ReqRX line to indicate a message is coming through. An acknowledge signal and/or a reset signal (RST) combine to reset the receiver 104 through a bank of AND gates 134.

FIG. 8 shows further details of the coder 120. The coder includes a sorter 140 that provides an output signal on S2, S3, S4, and S5 based on the number of logic high signals received on the input signal. This output signal from the sorter provides the upper two bits (b6, b7) of the data that switch a bank of multiplexers 144 between the input data or the, output of a block of control logic 142. The block of control logic 142 includes the following logic:

Bc5=d4/

Bc4=d4·d3·d2·d1+d2/·d0/

Bc3=d5·d2/+d4·d2/+d2·d1/+d5·d3·d0

Bc2=d5/·d0+d3·d1/+d4·d3/

Bc1=d2·d0/+d1/·d0+d2/·d0+d3/·d0+d5/·d4/·d3/·d1/

Bc0=d1

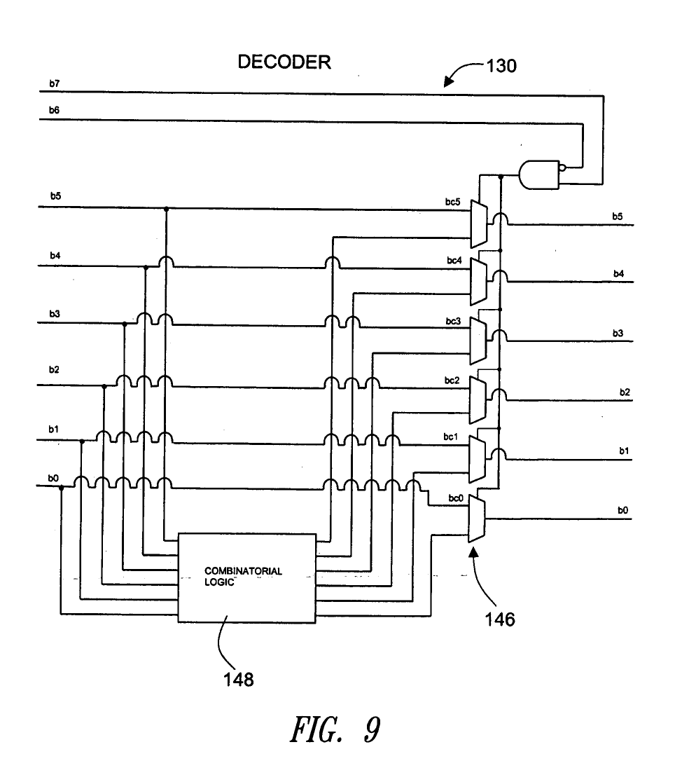

FIG. 9 includes further details of the decoder 130. The decoder includes a bank of multiplexers 146 controlled by the upper 2 bits of the input data. The multiplexers either pass the data on bits b0 through b5 straight through or pass through the data provided by combinational logic 148, which has the following logic:

Dc5=b3·b2/·b1/+b5/·b1

Dc4=b5/

Dc3=b4·b1·b0+b3/·b2·b1/+b5/·b3·b1+b3·b0

Dc2=b2·b1·b0/+b3·b1/·b0+b5/·b3/

Dc1=b0

Dc0=b2·b1+b2·b0+b3·b0

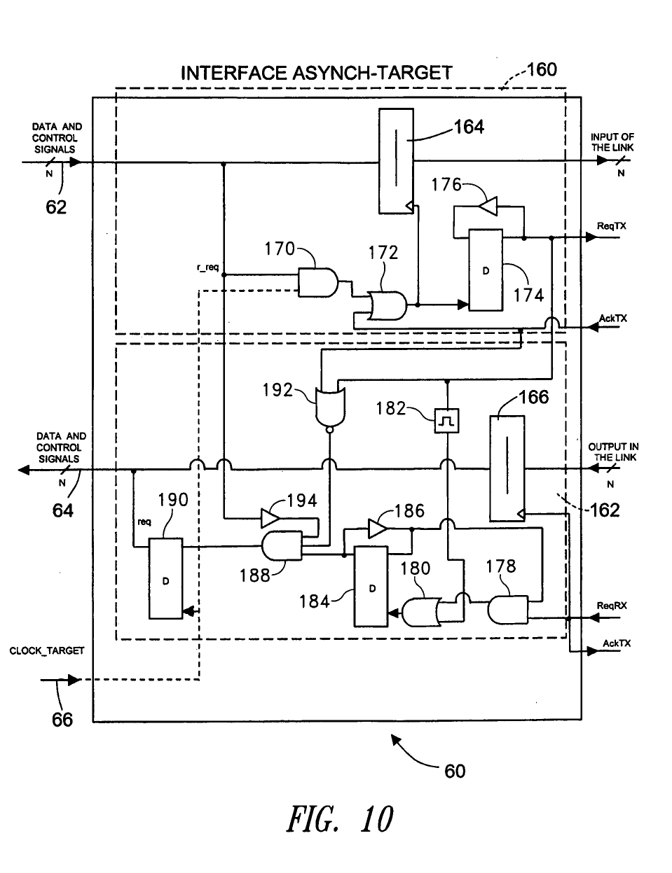

FIG. 10 provides further details of the synchronous interface portion 60. The asynchronous portion 58 is similar to the asynchronous portion 46 and will not be described again for sake of simplicity. The synchronous portion 60 includes two logic sections 160, 162. Logic section 160 receives the clock 66 from the target 42 as well as the data and control signals 62. A memory buffer 164 is responsive to the clock 66 for receiving and storing a communication from the target. When data is received in buffer 164, the ReqTX signal is activated indicating that data is ready to be transmitted to the asynchronous portion 58.

The second logic section 162 includes a memory buffer 166 that stores data to be transferred to the target 42. The ReqRX line is used to clock the memory buffer 166. The data in the memory buffer 166 is then transferred to the target 42 over data lines 64 in a synchronous manner using the target clock 66.

The first logic section 160 includes an AND gate 170 having a first input coupled to the target clock 66, a second input coupled to receive an r_req signal of the data and control signals 62, and an output coupled to a first input of an OR gate 172. The OR gate 172 has a second input coupled to receive the AckTX signal and an output coupled to a clock input of the buffer 164 and to a first input of a D flip-flop 174. The D flip-flop 174 has a second input and an output coupled to each other through a buffer gate 176, and the output supplies the ReqTX signal.

The second logic section 162 includes an AND gate 178 having a first input coupled to receive the ReqRX signal, a second input, and an output coupled to a first input of an OR gate 180. The OR gate 180 has a second input coupled via a one-shot 182 to the output of the D flip-flop 174 and an output coupled to a first input of a D flip-flop 184. The D flip-flop 184 has a second input and an output coupled to each other through a buffer gate 186 that is also coupled to the second input of the AND gate 178. The output of the D flip-flop 184 is also coupled to a first input of a three-input AND gate 188 having an output coupled to an input of another D flip-flop 190. The second input of the AND gate 188 is coupled to the output of a NOR gate 192 having inputs coupled respectively to the ReqTX and AckTX signals. The third input of the AND gate 188 is coupled via a buffer gate 194 to the r-req signal of the data and control signals 62. The D flip-flop 190 has a clock input that receives the target clock 66 and an output that supplies a req signal of the data and control signals 64.

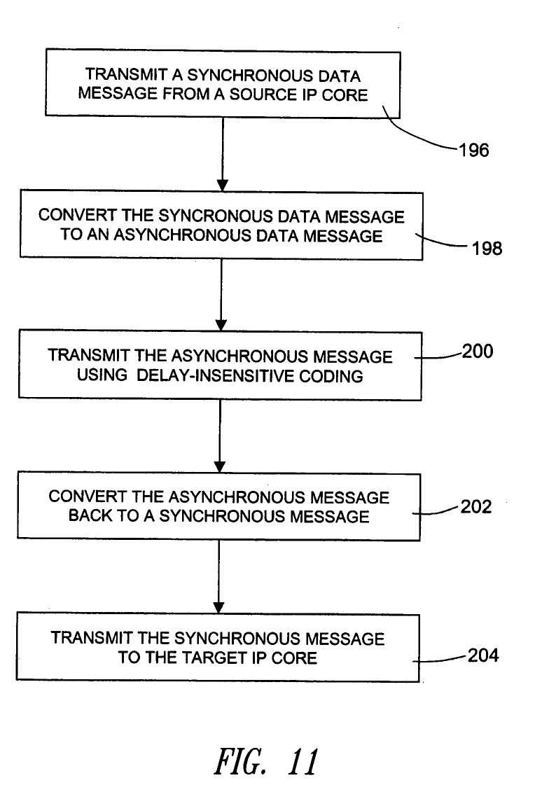

FIG. 11 shows a flowchart of the method for implementing transmission from a source IP core to a target IP core. In process box 170, a source IP core transmits a synchronous data message bound for a target IP core. In process box 172, the synchronous data message from the source IP core is converted to an asynchronous data message to implement delay-insensitive coding. In process box 174, the data message is transmitted in an asynchronous layer for a majority of the distance between the source and target IP cores. In process box 176, once in the vicinity of the target, the asynchronous message is again converted to a synchronous message. And in process box 178, the synchronous message is finally transmitted to the target IP core. To conversion from synchronous to asynchronous is transparent to the source and target IP cores.

Having illustrated and described the principles of the invention in a preferred embodiment, it should be apparent to those skilled in the art that the embodiment can be modified in arrangement and detail without departing from such principles.

For example, although a specific design is shown for converting synchronous communications to asynchronous, other designs may easily be used. For example, the logic in the coder or decoder may easily be modified.

Additionally, the illustrated circuits can be physically implemented, as in an operating circuit, or the circuits can be a symbolic representation, such as that generated on a computer. Typically, when generated on a computer, a net list is created for fabrication from the symbolic representation.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

In view of the many possible embodiments to which the principles or invention may be applied, it should be recognized that the illustrated embodiment is only a preferred example of the invention and should not be taken as a limitation on the scope of the invention. Rather, the invention is defined by the following claims. We therefore claim as the invention all such embodiments that come within the scope of these claims.

We claim:

1. A method of communicating between a source IP core and a target IP core in an integrated circuit, comprising:
transmitting, from the source IP core, a synchronous data message which is dependent on a first clock;
converting the synchronous data message to an asynchronous data message, which is independent of the first clock;
transmitting the asynchronous data message in a manner that implements delay-insensitive coding;
converting the asynchronous data message back into a synchronous data message, which is dependent on a second clock associated with the target IP core; and
transmitting the synchronous data message, which is dependent on the second clock, to the target IP core in a synchronous manner.

2. The method of claim 1 wherein both converting steps and the step of transmitting the asynchronous data message are accomplished using a decoupler.

3. The method of claim 1 wherein the first clock frequency is different from the second clock frequency.

4. The method of claim 3 wherein the first and second clock frequencies are asynchronous to each other.

5. The method of claim 1 wherein transmitting the asynchronous data message includes transmitting the data independent of a clock.

6. The method of claim 1, further including decoupling from the interconnect clock domain the target IP core.

7. An interface for communicating between different IP cores in an integrated circuit comprising:
a source IP core having a first synchronous clock domain;
a target IP core having a second synchronous clock domain; and
a decoupler coupled between the source IP core and the target IP core and structured to facilitate communication between the source IP core and the target IP core using asynchronous communication.

8. The interface of claim 7 wherein the decoupler includes an initiator interface positioned near the source IP core, a target interface positioned near the target IP core, and physical wires coupling the initiator interface to the target interface.

9. The interface of claim 8 wherein the initiator interface converts a data message from a synchronous domain to an asynchronous domain.

10. The interface of claim 7 wherein the decoupler includes two converters each of which convert communications between synchronous and asynchronous modes with a physical interconnection between the converters.

11. The interface of claim 10 wherein each converter includes at least one transmitter and one receiver.

12. The interface of claim 11 wherein each receiver includes a request detector that detects whether at least one active signal is received.

13. The interface of claim 11 wherein each transmitter includes a coder and a bank of AND gates, each AND gate having one input coupled to an output of the coder and a second input coupled to a delay.

14. The interface of claim 13 wherein each coder includes a sorter that detects the number of active signals input into the transmitter.

15. The interface of claim 11 wherein the receiver includes a decoder.

16. An interface for communicating between different IP cores in an integrated circuit, comprising:
a source IP core using first clock means;
a target IP core using second clock means, different than the first clock means; and
decoupler means for converting synchronous messages between the source and target IP cores to asynchronous messages;
the decoupler means including two interface means connected through interconnection means, one of the two interface means including means for converting synchronous communications from the source IP core to asynchronous communications, and the other of the two interface means including means for converting synchronous communications from the target IP core to asynchronous communications.

17. The interface of claim 16 wherein each interface means includes transmission means for transmitting to the other interface means and receiving means for receiving communications from the other interface means.

18. The interface of claim 17 wherein the receiving means includes detecting means for determining if a message is received.

19. The interface of claim 17 wherein the transmission means includes delay means for controlling the timing when the transmission occurs.
